(19) United States
(12) Patent Application Publication
(10) Pub. No.: US 2007/0165176 A1
(43) Pub. Date: Jul. 19, 2007

(54) DISPLAY PANEL AND TESTING METHOD FOR THE SAME

(76) Inventors: Po-Ju YANG, Tainan County (TW); Chih-Chan LIN, Tainan County (TW)

Correspondence Address: OSTROLENK FABER GERB & SOFFEN, 1180 AVENUE OF THE AMERICAS, NEW YORK, NY, 100368403, US

(21) Appl. No.: 11/623,544

(22) Filed: Jan. 16, 2007

(30) Foreign Application Priority Data
Jan. 17, 2006 (TW) 095101715

(51) Int. Cl. G02F 1/1345

(52) U.S. Cl. 349/149

(57) ABSTRACT

A display panel includes a display region, a connecting region, a pad region, and an extension region. The display region includes a plurality of scan lines and a plurality of data lines. The connecting region is formed with first and second connecting line units, each of which is electrically coupled to the scan lines and data lines. The pad region is formed with first and second pad units, each of which extends from the first and second connecting line units. The extension region is formed with an extension line unit that extends from the first pad unit. A testing method for a display panel is also disclosed.

### CROSS-REFERENCE TO RELATED APPLICATION

This application claims priority of Taiwanese application no. 095101715, filed on Jan. 17, 2006.

### BACKGROUND OF THE INVENTION

1. Field of the Invention

This invention relates to a display panel and a testing method therefor, more particularly to a display panel that can be safely tested using the testing method.

2. Description of the Related Art

FIG. 1 illustrates a conventional display panel 7 that includes an display region 71, first and second connecting regions 74, 75, a third connecting region 76, first and second pad regions 77, 78, and a third pad region 79.

The display region 71 on which images are displayed is formed with first and second sets of scan lines 73 and a set of data lines 72.

The first connecting region 74 is formed with a first connecting line unit that includes a plurality of connecting lines 741, each of which is connected electrically to a respective one of the scan lines 73 in the first set.

The second connecting region 75 is formed with a second connecting line unit that includes a plurality of connecting lines 751, each of which is connected electrically to a respective one of the data lines 72.

The third connecting region 76 is formed with a third connecting line unit that includes a plurality of connecting lines 761, each of which is connected electrically to a respective one of the scan lines 73 in the second set.

The first pad region 77 is formed with a first pad unit that includes a plurality of bonding pads 771, each of which extends from a respective one of the connecting lines 741 of the first connecting line unit.

The second pad region 78 is spaced apart from the first pad region 77, and is formed with a second pad unit that includes a plurality of bonding pads 781, each of which extends from a respective one of the connecting lines 751 of the second connecting line unit.

The third pad region 79 is spaced apart from the second pad region 78, and is formed with a third pad unit that includes a plurality of bonding pads 791, each of which extends from a respective one of the connecting lines 761 of the third connecting line unit.

It is noted that each of the bonding pads 771, 781, 791 of each of the first, second and third pad units is connected to a respective one of output pins (not shown) of a drive chip unit (not shown) when the drive chip unit is mounted on the display panel 7. It is noted that the drive chip unit, which serves to supply scan and data signals to the scan lines 73 and the data lines, may be mounted on the display panel 7 using either a chip-on-glass (COG) or a tape automated bonding (TAB) technique.

During testing of the conventional display panel 7, each of the first, second and third probes 8, 9, 10 of an aging test device (not shown) is connected to the connecting lines 741, 751, 761 of a respective one of the first, second and third connecting line units. Thereafter, the aging test device is operated such that a first voltage is applied to the scan lines 73 through the connecting lines 741, 761 of the first and third connecting line units and such that a second voltage is applied to the data lines through the connecting lines 751 of the second connecting line unit.

It is noted that a gap is required between each of the first and third connecting regions 74, 76 and the second connecting region 75 such that, during the testing of the conventional display panel 7, each of the first and third testing probes 8, 10 is separated from the second testing probe 9 by a distance (d) of at least 50 μm (preferably 200 μm). This is to ensure that direct physical contacts between the first and second probes 8, 9 and between the second and third probes 9, 10 can be prevented. However, this results in another problem, that is, the number of connecting lines 741, 751, 761 of the first, second and third connecting line units that can be formed on the first, second and third connecting regions 74, 75, 76 is considerably reduced.

### SUMMARY OF THE INVENTION

Therefore, the object of the present invention is to provide a display panel that can overcome the aforesaid drawback of the prior art.

According to the present invention, a display panel includes a display region, first and second connecting regions, first and second pad regions, and an extension region. The display region includes a plurality of scan lines and a plurality of data lines. Each of the first and second connecting regions serves to receive external driving signals. The first connecting region includes a first connecting line unit that is electrically coupled to the scan lines. The second connecting region includes a second connecting line unit that is electrically coupled to the data lines. The first pad region is formed with a first pad unit that extends from the first connecting line unit. The second pad region is formed with a second pad unit that extends from the second connecting line unit. The extension region is formed with an extension line unit that extends from one of the first and second pad units.

### BRIEF DESCRIPTION OF THE DRAWINGS

other features and advantages of the present invention will become apparent in the following detailed description of the preferred embodiments with reference to the accompanying drawings, of which:

FIG. 1 is a schematic circuit diagram of a conventional display panel;

FIG. 2 is a schematic circuit diagram of the first preferred embodiment of a display panel according to this invention;

FIG. 3 is a flowchart of the preferred embodiment of a testing method for the display panel according to the present invention; and

FIG. 4 is a schematic circuit diagram of the second preferred embodiment of a display panel according to this invention.

### DETAILED DESCRIPTION OF THE PREFERRED EMBODIMENTS

Before the present invention is described in greater detail, it should be noted that like elements are denoted by the same reference numerals throughout the disclosure.

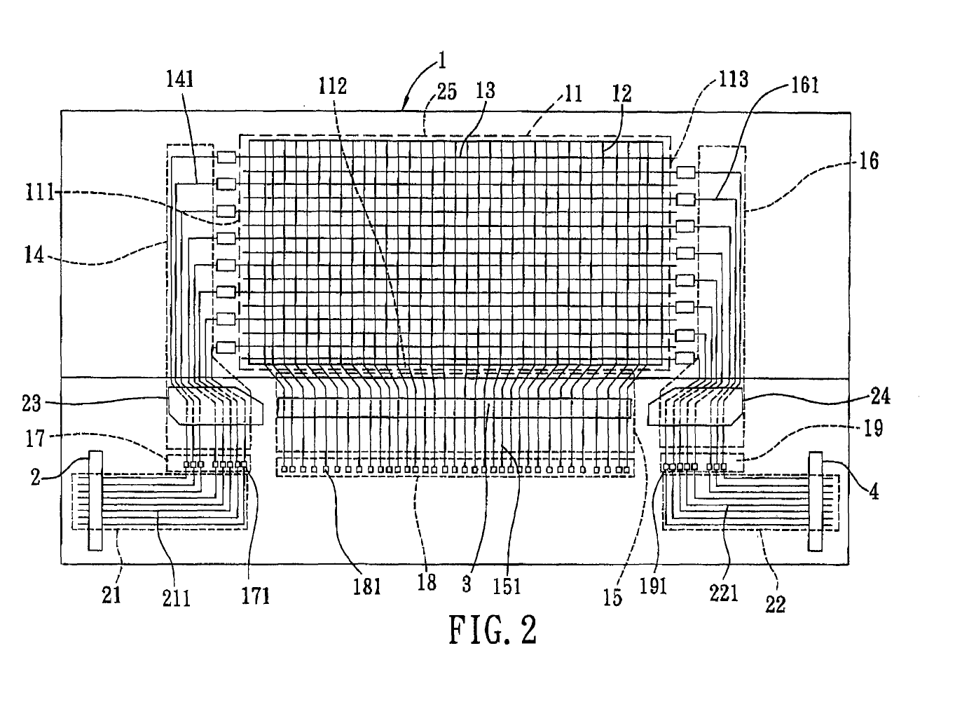

Referring to FIG. 2, the first preferred embodiment of a display panel 1 according to this invention is shown to include a display region 11, first and second connecting regions 14, 15, first and second pad regions 17, 18, and a first scan extension region 21.

The display panel 1 of this invention is applicable for a display, such as a liquid crystal display or an organic light-emitting diode (OLED) display.

The display region 11 on which images are displayed is formed with a scan line unit 13, which includes first and second sets of parallel scan lines, and a data line unit 12, which includes a set of parallel data lines transverse to the scan lines of the scan line unit 13. In this embodiment, the display region 11 is generally rectangular in shape, and has a first lateral side 111, and a second lateral side 112 transverse to the first lateral side 111.

The first connecting region 14 is disposed adjacent to and extends along the first lateral side 111 of the display region 11, and is formed with a first connecting line unit 141 that includes a plurality of connecting lines, each of which is electrically coupled to a respective one of the scan lines in the first set of the scan line unit 13.

The second connecting region 15 is disposed adjacent to and extends along the second lateral side 112 of the display region 11, is spaced apart from the first connecting region 14, and is formed with a second connecting line unit 151 that includes a plurality of connecting lines, each of which is connected electrically to a respective one of the data lines of the data line unit 12.

The display region 11 further has a third lateral side 113 that is opposite to the first lateral side 111 thereof.

The display panel 1 further includes a third connecting region 16 that is disposed adjacent to and that extends along the third lateral side 113 of the display region 11, that is spaced apart from the second connecting region 15, and that is formed with a third connecting line unit 161. In this embodiment, the third connecting line unit 161 includes a plurality of connecting lines, each of which is connected electrically to a respective one of the scan lines in the second set of the scan line unit 13.

The first pad region 17 extends from the first connecting region 14, and is formed with a first pad unit 171 that includes a plurality of bonding pads, each of which extends from a respective one of the connecting lines of the first connecting line unit 141.

The second pad region 18 extends from the second connecting region 15, and is formed with a second pad unit 181 that includes a plurality of bonding pads, each of which extends from a respective one of the connecting lines of the second connecting line unit 151.

The display panel 1 further includes a third pad region 19 that extends from the third connecting region 16, and that is formed with a third pad unit 191. In this embodiment, the third pad unit 191 includes a plurality of bonding pads, each of which extends from a respective one of the connecting lines of the third connecting line unit 161.

Each of the bonding pads of the first, second and third pad units 171, 181, 191 is connected to a respective one of output pins (not shown) of a drive chip unit (not shown) when the drive chip unit is mounted on the display panel 1 of this invention. The drive chip unit may be mounted on the display panel 1 using either a chip-on-glass (COG) technique, or a tape automated bonding (TAB) technique via a flexible printed circuit (FPC) board.

The first scan extension region 21 extends from the first pad region 17, is spaced apart from the first and second connecting regions 14, 15, and is formed with a first scan extension line unit 211 that includes a plurality of extension lines, each of which extends from a respective one of the bonding pads of the first pad unit 171.

The display panel 1 further includes a second scan extension region 22 that extends from the third pad region 19, that is spaced apart from the second and third connecting regions 15, 16, and that is formed with a second scan extension line unit 221. In this embodiment, the second scan extension line unit 221 includes a plurality of extension lines, each of which extends from a respective one of the bonding pads of the third pad unit 191.

The display panel 1 further includes first and second dielectric layers 23, 24, each of which is formed (by spin coating) on a respective one of the first and third connecting regions 14, 16 so as to insulate a portion of a respective one of the first and third connecting line units 141, 161, which is disposed adjacent to the second connecting region 15. As such, the dielectric layer 23 is disposed between the display region 11 and the first pad region 17, whereas the second dielectric layer 24 is disposed between the display region 11 and the second pad region 19.

The display panel 1 further includes a protective shield 25 that is disposed only above the display region 11. Since the specific configuration of the protective shield 25 is not pertinent to the present invention, a detailed description thereof is omitted herein for the sake of brevity.

It is noted herein that, in an alternative embodiment, the third connecting line unit 161 may be formed on the first connecting region 14, or alternatively, the first connecting line unit 141 may be formed on the third connecting region 16.

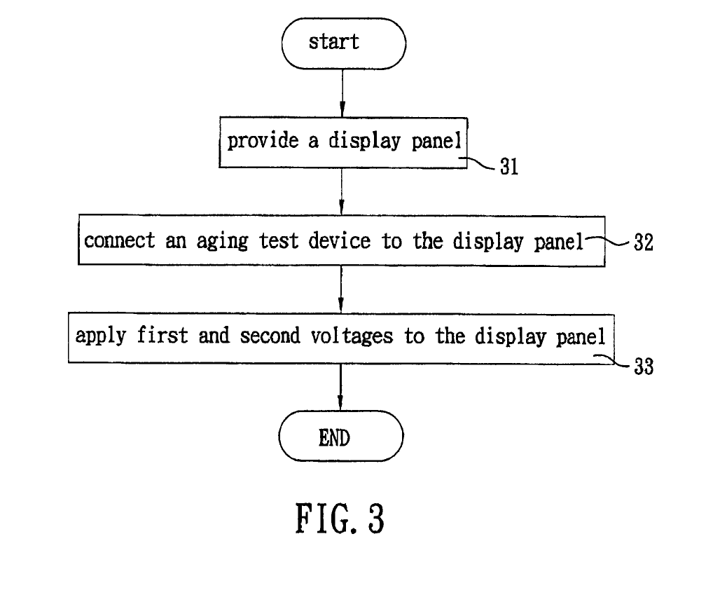

The first preferred embodiment of a testing method for the aforementioned display panel 1 according to the present invention includes the steps shown in FIG. 3.

In step 31, the display panel 1 is provided. In step 32, each of first, second and third testing probes 2, 3, 4 of an external aging test device (not shown) is connected to a respective one of the first and second scan extension line units 211, 221 and the second connecting line unit 151 of the display panel 1, thereby forming first, second and third electrical paths.

The first electrical path starts from the external aging test device, extends through the first testing probe 2, the first scan extension line unit 211, the first pad unit 171, the first connecting line unit 141, and ends at the scan lines in the first set of the first scan line unit 13.

The second electrical path starts from the external aging test device, extends through the second testing probe 3, the second connecting line unit 151, and ends at the data line unit 12.

The third electrical path starts from the external aging test device, extends through the third testing probe 4, the second scan extension line unit 221, the third pad unit 191, the third connecting line unit 161, and ends at the scan lines in the second set of the first scan line unit 13.

In step 33, the aging test device is operated such that a first voltage is applied to the scan line unit 13 and a second voltage is applied to the data line unit 12.

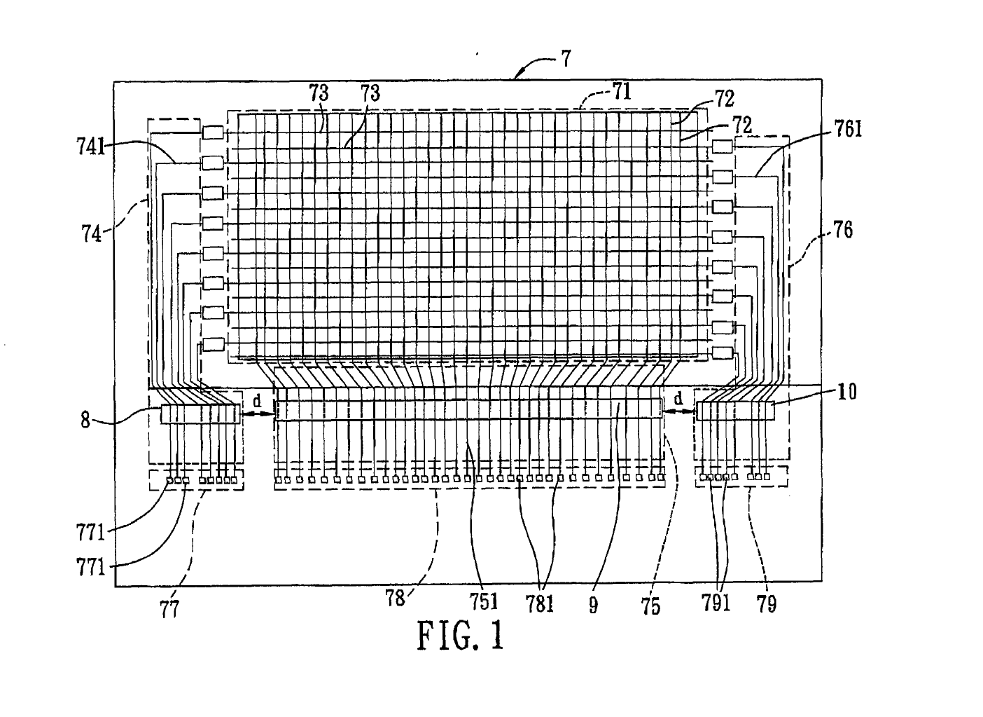

It is noted that since the first testing probe 2 of the aging test device is connected to the first scan extension line unit 211 instead of the first connecting line unit 141 and since the third testing probe 4 of the aging test device is connected to the second scan extension line unit 221 instead of the third connecting line unit 161, unlike in the conventional display panel 7 (see FIG. 1), no gap is required between each of the first and third connecting regions 14, 16, and the second connecting region 15 of the display panel 1 of this invention. As a result, the number of connecting lines of the first, second and third connecting line units 141, 151, 161 that can be formed on the first, second and third connecting regions 14, 15, 16 of the display panel 1 can be considerably increased. Furthermore, the prevention of direct physical contact between the first and second testing probes 2, 3 and between the second and third testing probes 3, 4 during the testing of the display panel 1 of this invention can be ensured.

It is also noted that each of the first and second dielectric layers 23, 24 serves as an insulator to prevent the second testing probe 3 from accidentally making direct physical contact with the first and third connecting line units 141, 161 during the testing of the display panel 1 of this invention.

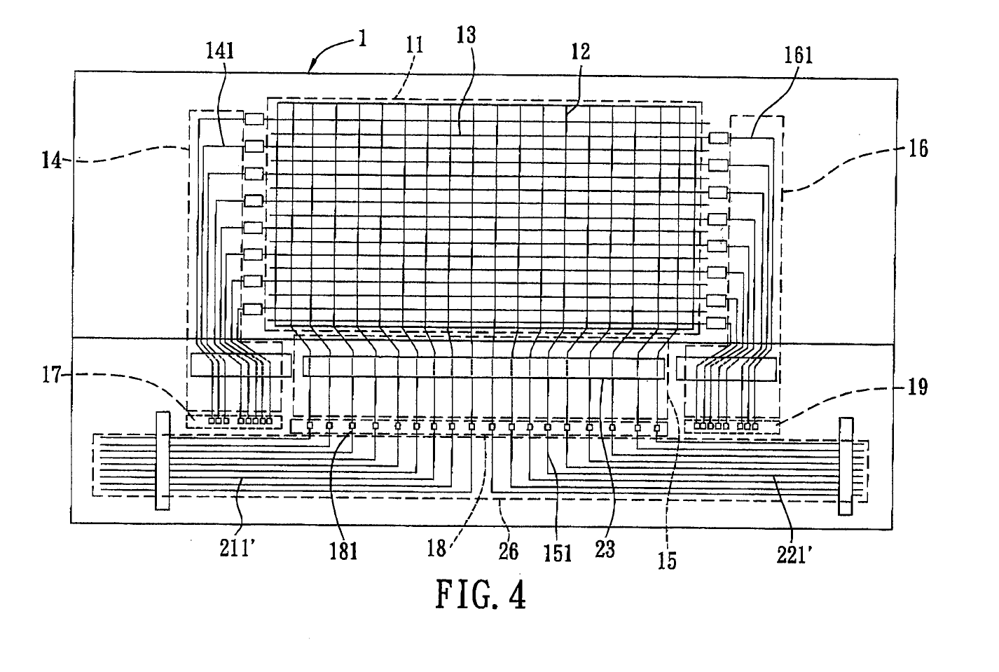

FIG. 4 illustrates the second preferred embodiment of a display panel 1 according to this invention. When compared to the previous embodiment, the display panel 1 is dispensed with the first and second scan extension regions 21, 22 (see FIG. 2), and the first and second scan extension line units 211, 221 (see FIG. 2).

In this embodiment, the display panel 1 further includes a data extension region 26, and first and second data extension line units 211′, 221′. The data extension region 26 extends from the second pad region 18, and is spaced apart from the first, second and third connecting regions 14, 15, 16. Each of the first and second data extension line units 211′, 221′ includes a plurality of extension lines, each of which extends from the bonding pads of the second pad unit 181.

Moreover, the display panel 1 is dispensed with the second dielectric layer 24 (see FIG. 2). The first dielectric layer 23 is formed on the second connecting region 15 so as to insulate a portion of the second connecting line unit 151, which is disposed adjacent to the first and third connecting line units 141, 161.

Since the testing method for the display panel 1 of the second preferred embodiment is similar to that described hereinabove in connection with the display panel 1 of the first preferred embodiment, a detailed description of the same will be dispensed with herein for the sake of brevity.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A display panel, comprising:
a display region including a plurality of scan lines and a plurality of data lines;
first and second connecting regions for receiving external driving signals, said first connecting region including a first connecting line unit that is electrically coupled to said scan lines, said a second connecting region including a second connecting line unit that is electrically coupled to said data lines;
a first pad region formed with a first pad unit that extends from said first connecting line unit;
a second pad region formed with a second pad unit that extends from said second connecting line unit; and
an extension region formed with an extension line unit that extends from one of said first and second pad units.

2. The display panel as claimed in claim 1, wherein said extension line unit extends from said first pad unit, said display panel further comprising a dielectric layer that is formed on said first connecting region so as to insulate a portion of said first connecting line unit, which is adjacent to said second connecting region.

3. The display panel as claimed in claim 2, wherein said dielectric layer is disposed between said display region and said first pad region.

4. The display panel as claimed in claim 1, wherein said extension line unit extends from said second pad unit, said display panel further comprising a dielectric layer that is formed on said second connecting region so as to insulate a portion of said second connecting line unit, which is adjacent to said first connecting region.

5. The display panel as claimed in claim 4, wherein said dielectric layer is disposed between said display region and said second pad region.

6. The display panel as claimed in claim 1, further comprising a protective shield disposed above said display region.

7. The display panel as claimed in claim 6, wherein said protective shield is disposed only above said display region.

8. A display panel comprising:
a display region including a plurality of parallel scan lines, and a plurality of parallel data lines transverse to said scan lines;
first and second connecting regions for receiving external driving signals, said first connecting region including a first connecting line unit that is electrically coupled to said scan lines, the second connecting region including a second connecting line unit that is electrically coupled to said data lines;
a first pad region formed with a first pad unit that extends from said first connecting line unit;
a second pad region formed with a second pad unit that extends from said second connecting line unit; and
an extension region formed with an extension line unit that extends from one of said first and second pad units, and that is adapted to be connected to an external aging test device such that an electrical path is formed starting from the external aging test device, extending through said extension line unit, said one of said first and second pad units, a corresponding one of said first and second connecting units, and ending at a corresponding one of said scan lines and said data lines.

9. The display panel as claimed in claim 8, wherein said extension line unit extends from said first pad unit, said display panel further comprising a dielectric layer that is formed on said first connecting region so as to insulate a portion of said first connecting line unit, which is adjacent to said second connecting region.

10. The display panel as claimed in claim 9, wherein said dielectric layer is disposed between said display region and said first pad region.

11. The display panel as claimed in claim 8, wherein said extension line unit extends from said second pad unit, said display panel further comprising a dielectric layer that is formed on said second connecting region so as to insulate a portion of said second connecting line unit, which is adjacent to said first connecting region.

12. The display panel as claimed in claim 11, wherein said dielectric layer is disposed between said display region and said second pad region.

13. The display panel as claimed in claim 8, further comprising a protective shield disposed above said display region.

14. The display panel as claimed in claim 13, wherein said protective shield is disposed only above said display region.

15. A testing method for a display panel, comprising:
A) providing a display panel including
an display region including a plurality of parallel scan lines, and a plurality of parallel data lines transverse to the scan lines,
first and second connecting regions for receiving external driving signals, the first connecting region including a first connecting line unit that is electrically coupled to the scan lines, the second connecting region including a second connecting line unit that is electrically coupled to the data lines,
a first pad region formed with a first pad unit that extends from the first connecting line unit,
a second pad region formed with a second pad unit that extends from the second connecting line unit, and
an extension region formed with an extension line unit that extends from one of the first and second pad units, and adapted to be connected to an external aging test device such that an electrical path is formed starting from the external aging test device, extending through the extension line unit, said one of the first and second pad units, a corresponding one of the first and second connecting units, and ending at a corresponding one of the scan and data line units;
B) connecting first and second testing probes of the external aging test device to the extension line of said one of the first and second connecting line units, and the other of the first and second connecting line units; and
C) operating the external aging device such that a first voltage is applied to the scan line unit and such that a second voltage is applied to the data line unit.

16. The testing method as claimed in claim 15, wherein, in step A), the display panel further includes
a dielectric layer that insulates a portion of the first connecting line unit, and that is disposed between the display region and the first pad region, and
a protective shield that is disposed above the display region.
